(19) United States
(12) Patent Application Publication
(10) Pub. No.: US 2007/0217641 A1
(43) Pub. Date: Sep. 20, 2007

(54) Ear Gear

(76) Inventor: Mark Bryan Rosal, Winfield (CA)

Correspondence Address: Mark Bryan Rosal, 11651 McGowan Road, Winfield, BC, V4V 1J2, CA

(21) Appl. No.: 11/376,637

(22) Filed: Mar. 15, 2006

(51) Int. Cl. H04R 25/00

(52) U.S. Cl. 381/330; 381/322; 381/328

(57) ABSTRACT

Ear Gear is a Hearing Aid security protection device that protects Hearing Aids from loss, moisture wind and dirt while making them more comfortable to wear. Made from spandex or other materials, Ear Gear comes in a variety of colors. The Ear Gear sleeve and cord come in a variety of lengths and widths to fit different types of Hearing Aids: BTEs, ITEs, Minis, Cochlear, FM. There are eight models. Ear Gear has a small opening at the top and a large opening at the bottom. There is a left and right sleeve attached to stretch cord connected to a clip which attaches to clothing. Remove the earmold from the Hearing Aid; the top of the Hearing Aid slides through the bottom of the Ear Gear sleeve through to the top where it locks. The earmold is reattached. Variations include mono, binaural, cordless, closed bottom, open back and flap cover.

### FIELD OF INVENTION

Ear Gear is a casing that covers various types of hearing aids, Behind the Ear (BTE) models including Cochlear processors and In the Ear (ITE) models. The ear mold is removed from the BTEs, and then the hook of the BTE slips into the larger hole at the bottom of the Ear Gear sleeve. The hook part of the BTE comes out of the smaller hole at the top. The ear mold is then reattached to the BTE hook. For the ITE model, the Ear Gear sleeve is modified, and slips over the top of the ITE, leaving the inner mold exposed. There are currently eight models available and new ones under development.
1. Original Binaural & Mono, Original cordless
2. FM Binaural & Mono, FM cordless
3. Infant Binaural & Mono, Infant Binaural & Mono FM
4. Cochlear, Cochlear cordless
5. Mini, Mini cordless
6. ITE Binaural & Mono, ITE cordless
7. Open back
8. Bottom closed sleeve
Ear Gear Original Binaural has a cord, approx. 16 inches long, either end of the cord attaches to a left and right sleeve. The centre of the cord is attached to a clip which in turn attaches to clothing such as shirt, jacket, or sweater. The cord also has a plastic cinching ring that allows the user to adjust the cord length and limits the bi-lateral movement of the hearing instruments.
Ear Gear Original Mono has a single cord, approx. 8 inches long, that attaches to a single sleeve. The cord is attached at one end to the sleeve and at the other end to the clip which in turn is attached to clothing.
The Ear Gear Original sleeve is 1¾ inches long, (approx. length) to fit most BTE's. It has an approx. ¼ inch opening at the top of the sleeve and a slightly wider opening at the bottom, approx. ⅝ inch, the width of the sleeve at the middle is approx. 3/4 inch. Other variations include Ear Gear Original Cordless, Ear Gear Original Binaural & Mono Open Back, Ear Gear Original Binaural & Mono Closed Bottom. Each variation was developed to accommodate different of Hearing Aids models and the different needs of Hearing Aid users.
Ear Gear FM Binaural like Ear Gear Original also has a cord, approx. 16 inches long, & clip. However, the FM sleeve is longer, approx. 2¾ inch, to adjust for the attachment of an FM unit at the bottom of a BTE unit. Ear Gear FM Mono is also available; like the Ear Gear Original Mono there is a shorter cord, approx. 8 inch long, that attaches a single sleeve. Other variations to Ear Gear FM include Ear Gear FM Cordless, Ear Gear FM Binaural & Mono Open Back, Ear Gear FM Binaural & Mono Closed Bottom.
Ear Gear Infant Binaural is a variation of the Ear Gear Original, the cord lengthen is shorter, approx. 12 inches long. There is a left and right sleeve that attaches to either end of the 12 inch lengthen of cord. It also has a plastic cinching ring that allows the user to adjust the cord length and limits the bi-lateral movement of the hearing instruments. Ear Gear Infant Mono is available; a single cord is also half the length of the Ear Gear Infant Binaural (approx. 6 inches long) and attaches to a single sleeve. The Ear Gear Infant and Ear Gear Original sleeve is the same size and fits a 1¾″ (approx. length) BTE.
Ear Gear Infant FM Binaural is a variation of Ear Gear FM. Ear Gear Infant FM also has a cord, approx. 12 inches long. There is a left and right sleeve that attaches to either end of the 12 inch lengthen of cord. Ear Gear Infant FM Mono is available; a shorter cord, approx. 6″ long, attaches to a single sleeve. Like the Ear Gear FM, the Ear Gear Infant FM Binaural & Mono sleeve is longer, approx. 2¾″, to adjust for the attachment of an FM unit at the bottom of the BTE.
Ear Gear Original Cordless and Ear Gear FM Cordless were developed because some Hearing Aid users do not need or want the security provided by the cord and clip. Some Hearing Aid users want to protect their Hearing Aid instruments from sweat, moisture and dirt. In addition, they want to protect their ears from chaffing.
Ear Gear Open Back was developed because some Hearing Aid users need to have access to the Volume controls located at the back of some Hearing Aid instruments. The Open Back may be closed with a flap, a fastener, such as a Velcro strip, or a hook and eye.
Ear Gear Closed Bottom was developed because some Hearing Aid users want to ensure that their Hearing Aid is enclosed. This is particularly important for FM Hearing Aid Instruments. Many FM units are a boot that attach to a Hearing Aid and the users want to ensure that the boot does not slip off and fall through the opening at the bottom. The bottom may be closed either by being sewn or with a fastener such as a Velcro strip or hook and eye.
Ear Gear Original Binaural & Mono, Ear Gear FM Binaural & Mono, Ear Gear Infant Binaural & Mono, Ear Gear Infant FM Binaural & Mono can all be adapted to include an Open Back and/or a Closed Bottom.
Ear Gear Cochlear is similar to Ear Gear Original but the width of the sleeve is longer to accommodate the larger Cochlear processor. While Ear Gear Original has approx. a ¼ inch opening, the Ear Gear Cochlear has approx. a ⅝ inch opening at the top. The Ear Gear Original is approx. ¾ inch wide at the centre, while the Ear Gear Cochlear is approx. 1¼ inches wide at the centre. The Ear Original and the Ear Gear Cochlear both have an opening of ⅝ inch at the bottom. Additionally, all Ear Gear Cochlear models have an Open Back to accommodate the short wire cord that attaches the BTE processor to the actual Cochlear hearing Instrument. Ear Gear Cochlear FM and Ear Gear Cochlear Cordless is also available.

Some Cochlear BTE users also have one standard BTE on one ear and a Cochlear process on the other ear, there will be a model available that can accommodate the Cochlear BTE processor and a standard BTE with cord and clip.
Ear Gear Mini Binaural again like the Ear Gear Original Binaural has a cord, approx. 16 inches long, either end of the cord attaches to a left and right sleeve. Ear Gear Mini Mono is available, a shorter cord, approx. 8 inches long, attaches to a single sleeve. Ear Gear Mini Binaural & Mono have a sleeve that comes in various sizes to fit different styles and models of “Open Fit” BTE's. “Open Fit” BTE's are less then 1¾ inches long. Ear Gear Mini Cordless, Ear Gear Mini Binaural & Mono Open Back and Ear Gear Mini Binaural & Mono Closed Bottom are also available.
Ear Gear ITE is made to accommodate Hearing Aids worn in the ear. There are various sizes of ITE and consequently Ear Gear ITE comes in sizes to accommodate the various sizes of the ITE. Ear Gear ITE sleeve is different from the Ear Gear Original sleeve. It is shorter. The sleeve can range from approx. ¾ inches to 1¼ inches in lengthen. Ear Gear ITE Original has a sleeve that is closed at the top and opens at the bottom. Ear Gear ITE Open has a sleeve that is open on both ends. Ear Gear ITE Original and Ear Gear ITE Open both have a cord that is approx. 16″ long, and either end of the cord attaches to a left and right sleeve. Ear Gear ITE Original and Ear Gear ITE Open are both available in Mono model, a shorter cord, approx. 8 inches long, and attaches to a single sleeve. Other variations to Ear Gear ITE Original and Ear Gear ITE Open are cordless models.

Hearing Aid Instruments come in many shapes and sizes. Ear Gear models have been adapted to fit the standard sizes but can also be special ordered to meet the needs of specific users.

The Ear Gear also comes in fashionable colors that can be made to match the persons BTE hearing aid ear molds. The person can move more freely as the Ear Gear provide security and comfort. Ear Gear wicks away moisture and prevents chaffing, it also helps protect the Hearing Aid batteries which burn out when exposed to excessive moisture. The Ear Gear casing is attractive to wear.

### BACKGROUND OF THE INVENTION

Hearing aids are hard objects about the size of a thumb that fit Behind the Ear (BTE) or In the Ear (ITE). They come in various lengths and widths. Additionally, there are also Cochlear models that are surgically inserted behind the ear and include a processor that resembles the BTE Hearing Aids. Hearing Aid Instruments are made of plastic and are designed to improve hearing. A set of digital Hearing Aid Instruments can range in price from $2,000.00 to $8,000.00 USD. The average cost of a set of BTEs is $2,500.00 USD and would cost approximately $165.00 per year to have insured. ITEs, BTEs and BTE Cochlear are worn by young children, adults and elderly people with a range of special needs.

Some young children who are hard of hearing also have other developmental delays while some elderly individuals may have dementia, or simply may be forgetful. Both young children and elderly people with impaired mental functioning will from time to time will take off their BTEs, ITEs or BTE Cochlear and discard them. They do not put them in a safe place.

Furthermore, the hearing aid instruments can squeal and cause irritation while all models can cause perspiration and chaffing. This is a problem as the wearer can develop sores behind their ear or in their ear, additionally when Hearing Aid Instruments are exposed to moisture the batteries burn out more quickly. Hearing Aids can fall off when a person is running or involved in a sporting activity such as Tennis or Soccer.

Some Hearing Aid users may pull their Hearing Aid Instruments off and discard them with no thought, or memory as to where the Hearing Aids Instruments were left. The irritation and chaffing can also cause some wearers to use their Hearing Aid Instruments less and in the case of children or older people, it may cause them to take them off. This can cause the hearing aids to be misplaced or lost.

There are three other security devices on the market, and two other devices that attempt to reduce the amount of moisture that Hearing Aid Batteries are exposed to.

One product was developed by PHONAK and is called Kids Clip, they retail at approx. $9.00 USD. It has a small plastic ring that surrounds a BTE Hearing aid. Each plastic ring is then attached to a long (16″) cord that meet at the centre attaching to a clip. The clip then attaches to clothing. The PHONAK plastic ring breaks with little wear and tear and can easily be chewed by a small child that would put the device in their mouth.

The second security device is called a Huggie Catchar and retails for approx. $20.00 USD for a standard model. It has a larger plastic ring that goes around the ear. The main plastic ring has two plastic rings that go around the BTE at the top and bottom. This device also has a plastic cord that attaches to a clip used to secure it to clothing. The main plastic ring that goes around the ear looks strange and could attract negative attention from other children. This devise is also cumbersome and makes the Hearing Aids even more uncomfortable on small ears.

The third security device is called an Oto clip. It is one piece of string. At each end there is a loop created by the plastic and a clip at the centre that attaches to clothing. This device is difficult to place on the BTE's and still does not provide adequate security since the loop can slip open or the plastic piece can break off. The string is light weight but does not provide flexibility as there is no elasticity to the unit. Oto clips retail for approx. $13.90USD.

There is also a two devices that try to protect Hearing Aids from moisture. These are the Hearing Aid Sweatband and Super Seals.

Super Seals are flexible latex covers made for hearing aid moisture protection. They will protect the amplifier, case, controls and battery compartment of your hearing aids while leaving an opening for sound to enter the microphone. While Super Seals may protect Hearing Instruments from moisture they do not reduce chafing. In addition, they do not provide security. Super Seal do not let moisture in but conversely they also trap moisture. In addition, the natural rubber latex may cause allergic reactions. Super Seal retails for $24.95USD for the starter kit and seals which includes a device for getting them on the Hearing Aid.

The Hearing Aid Sweat Band is made from a specially designed fabric that is both moisture repellent and moisture absorbent, but does not inhibit sound. It is disposable and has limited wear. The Hear Aid Sweat Band retails at $16.95USD.

Hearing Aid Sweat Band and Super Seals may protect Hearing Instruments batteries from perspiration, moisture, dirt and grim but they do not protect the wearer's ear from chaffing or loss and are not as durable or as affordable as Ear Gear.

Ear Gear is a security device. It was designed by the inventor frustrated by the ineffectiveness of the PHONAK unit and awkwardness of the Huggie Catchar and his inability to find a security device for the BTEs worn by his special needs daughter. Once his daughter hid the BTEs inside of a bag under a couch at grandmas, it took a month before they were found. The illogical capricious behavior of his daughter is common in young children and in some Elderly people who suffer with dementia or other illness that impair mental functioning. The inventor's daughter not only threw the BTEs away but she'd chew off the plastic attachment—this meant that the inventor's family purchased a new Kids Clip every other month. When the child was involved in active play, the BTEs tended to fall off and get lost, and often the parents removed the BTEs. Additionally, the inventor's daughter typically had open sores on the back of her ear which was irritating, especially in summer.

### SUMMARY OF THE INVENTION

The Ear Gear unit is designed to fit securely and snuggly around the BTEs. The sleeve comes in two standard sizes. The original sleeve is 1¾ inches long (approx. length) and fits most BTE. The FM sleeve is approx. 2¾ inches long (approx length) and fits a BTE with a FM attachment. Both sleeves have an approx. 1/4 inch opening at the top of the sleeve and a slightly wider opening approx. ⅝ inch at the bottom, of the sleeve and the middle of the sleeve is approx. ¾ inch. The BTE's are slipped into the larger opening at the bottom of the casing and through the smaller opening at the top. The BTE is held firmly in place as the smaller opening is only as large as the top of the BTE that attaches to the ear mold. This ensures that the sleeve can not slip off and are securely attached to the BTE's. To remove the Ear Gear sleeve from the BTE one would have to slip it off deliberately. There is a left and right sleeve. Attached to each of the sleeves is a piece of stretchy cord, approx. 16 inches for adult users, and approx. 12 inches long for infant and children users. Mid way along the lengthen of the cord, a clip is fastened. The clip in turn attaches to outer garments, shirts, jackets or even to a little girls pony tail! Ear Gear ensures that the BTE cannot easily be removed, thrown away or lost.

Concerned that the sleeve might cause a drop in the clarity of sound received by BTEs microphones, an independent audiologist tested them and found the loss of volume was less than 1 db, and insignificant.

One advantage of Ear Gear invention with cord attached is that when the BTEs fall off the person's ears, the BTEs will now be securely in cased inside the bootie and hang down around the person's body. If the person is intent on removing the Ear Gear unit from their clothing and discarding it in a room they are much easier to find because the Ear Gear are colored.

An advantage of the Ear Gear FM is the stretch fabric of the sleeve holds the BTE FM attachment securely in place.

Another advantage of the Ear Gear is that the fabric is light weight and soft. It both repels and absorbs moisture but does not inhibit sound.

An additional advantage is that Ear Gear protects Hearing Instruments from shutting off because of moisture from perspiration, rain or snow, and stops dust and dirt infiltration. Controls can be easily operated even with the Ear Gear in place. The protective covering simply slips over the hearing aid and there is no need for an application procedure or special tool.

Another advantage of Ear Gear is that reduces chaffing around the top of the ear and there is less irritability for the individual wearer.

Previous to the Ear Gear, the inventor removed his child's hearing aids during activities such as dance or even outdoor play. Now if the child is involved in an activity like dance, soccer or outdoor play then she can still wear her BTEs and listen to instruction from a teacher or coach. The Ear Gear provide security—the BTEs are less likely to fall off and the Ear Gear provide more comfort. When the person perspires the fabric will absorb the moisture and cause less chaffing.

Finally, Ear Aids will come in wide range of colorful materials that make them more fashionable and fun to wear. This invention takes the dull drab and technical aspect of hearing aids and turns them into a fashion accessory. The inventor anticipates that Ear Gear will retail for between $15.00 -$35.00USD per unit, depending on the model.

Other potential application of the Ear Gear was suggested by the inventor's daughter's audiologist. It can be used for elderly patients who are forgetful, erratic or suffer with dementia. Elderly patients take their aids off and don't remember where they put them or they take the aids off and deliberately try to hide them. The inventor also anticipates that any hard of hearing person who is involved in Sports or other activities might want the additional security provided by Ear Gear. The clip is sturdy and can not be easily removed from clothing.

The inventor anticipates that any material with stretch such as neoprene, spandex, wool or cotton could be used to manufacture the Ear Gear. Variation to the Ear Gear could include knitting the sleeve so that the cord and the sleeve would be one integral unit. At the moment the cord is sewn to the sleeves and reinforced with rubber glue.

There are several variations that can be made to the sleeve. One variation is the length of the sleeve. It can be shorter or longer to accommodate a range of BTEs or ITEs. For BTE use the sleeve may be open at the back, so that users can access controls more easily, this open back can also include a flap, fastener such as a Velcro slip or a hook and eye. Another variation that can be made to the sleeve on BTE models is to close the bottom either by sewing it shut or again by applying a flap, fastener such as a Velcro skip or hook. Some FM users want the extra security provided by the closed bottom. For the ITE model the sleeve will be considerably shorter and come in various sizes to accommodate a range of ITE models. The ITE sleeve maybe open at the top or closed at the top and open at the bottom to accommodate the insertion of the ITE into the ear.

There are also several variations that can be made to the Ear Gear cord. The cord can be shortened or lengthened to accommodate infant, children and adult users. The cord can also adjusted to accommodate mono models. If the cord on the Ear Gear Original is 16 inches long and 12 inches long on the Ear Gear Infant then the Ear Gear Original Mono cord would be 8 inches long and the Ear Gear Infant Mono would be 6 inches long.

Ear Gear cordless is another variation of the original invention.

### BRIEF DESCRIPTION OF THE DRAWINGS:

1. A Hearing Aid security and protection device encompassing: a sleeve in the same shape as a BTE hearing aid providing security and soft resilient comfort to a wearer. The sleeve has a small opening at the top, approx. ¼ inch long for securely fitting over the hearing aid hook and onto the body of the hearing aid. There is a larger approx. 5/8 inch opening on the bottom that provides access to the battery compartment. The sleeve may range from one inch or less in length (Mini) to long as 2¾ inches (FM) or longer. The Original sleeve is approx. 1¾ inches long.
2. There is a left and right sleeve made of a light woven, breathable fabric. Sleeves can be made from a wide range of fabrics including neoprene, spandex, cotton, and wool. The sleeve may range from one inch or less in length and accommodate an “Open Fit” BTE.

It can also range from 2¾ inches long or more and accommodate an FM boot. The Original sleeve is approx. 1¾ inches long.
3. A sleeve in the same shape as an ITE hearing aid providing security and soft resilient comfort to a wearer. The sleeve will either be open at the top or sewn shut. The top of the ITE sleeve is approx. ⅝ inch long and fits securely over the ITE hearing aid. The ITE sleeve covers the outer exposed area of the ITE hearing aid and leaves the ear mold uncovered. The bottom of the ITE sleeve is approx. ¼ inch long and reinforced with stitching. Sleeves can be made from a wide range of fabrics including but not limited to neoprene, spandex or a jersey cotton knit.
4. Attach to the centre back of each sleeve there is piece of stretchy cord that will typically range from approx. 16 to 12 inches in length either sewn to the sleeve or woven from the back in one continuous piece. The left sleeve and right sleeve will both be attached to either end of the cord and at the centre of the cord there will be a clip attached.
5. The cord will be of equal length and attach at the centre to small clip about 2 inches in diameter. It may be one single piece of cord that slides through a cylinder piece of metal attached to the top part of the clip, or the cord maybe attached to the clip in another mode.
6. The clip or fastening device could be plain or could have a range of attractive designs and colors on the surface.
7. There is a cordless variation. The sleeve is used alone.
8. There is a mono variation—the cord length will be approx. half as long as the cord length for the binaural model. There will only be one sleeve attached to the cord and clip. The cord is attached to the clip by a piece of metal secured to the clip and clamped around the cord.
9. Another variation is an open back sleeve variation. There is an opening that is reinforced with stitching and allows access to controls. This opening may include a fastener such as a Velcro strip or hook and eye.
10. Another variation of the BTE sleeve would include a closed bottom. The bottom may be sewn shut or closed by incorporating a fastener into the design.

The embodiments of the invention in which an exclusive property or privilege is claimed are defined as follows:

FIG. 1 is a partially schematic illustration of a woman wearing a form of apparatus of the present invention.

FIG. 2 is a full view of the present invention, the Ear Gear Original unit.

FIG. 3 is a partially schematic illustration of a Ear Gear sleeve inside a BTE and attached to an ear mold.

FIG. 4a is a sectional illustration of the sleeve portion of the Hearing Aid. The view is of the bottom and top openings before the BTE is slipped inside, as shown in FIG. 3.

FIG. 4b is also a sectional illustration of the sleeve portion of the Hearing Aid. The view is of the sleeve is from behind, it further illustrates how the cord is attached to the sleeve.

FIG. 5 is a view of the sleeve; it further illustrates the sleeve variations: original, FM, Mini, Original closed bottom, Original open back, Cochlear model.

FIG. 5a illustrates the Original sleeve that is approx. 1¾ inches long.

FIG. 5b illustrates the FM sleeve that is approx. 2¾ inches long.

FIG. 5c illustrates the Mini sleeve that is approx. 1 inch long or less.

FIG. 5d illustrates the Original sleeve Closed Bottom

FIG. 5e illustrates the Original sleeve Open Back reinforced with stitching.

FIG. 5f illustrates the Cochlear sleeve—which is wider.

FIG. 6 is a view of the full view of the present Ear Gear unit. It further illustrates the cord variations.

FIG. 6a illustrates the Original cord that is approx. 16 inches long, and attached to a left and right sleeve. The cord slides through a cylinder shaped piece of metal that is attached to the top of the clip.

FIG. 6b illustrates the Infant cord that is approx. 12 inches long, and attached to a left and right sleeve. The cord slides through a cylinder shaped piece of metal that is attached to the top of the clip.

FIG. 6c illustrates the Mono cord that is approx. half the length of the Original—8 inches long, and attached to a single sleeve. The cord is encased in a cylinder shaped piece of metal that is attached to the top of the clip.

FIG. 7 is a full view of the present invention, the Ear Gear ITE unit.

FIG. 7a illustrates the Ear Gear ITE unit closed on the top so that it encases the ITE Hearing Instrument; it further illustrates the cordless variation of the Ear Gear ITE.

FIG. 7b illustrates a variation of the Ear Gear ITE sleeve, open on the top; it further illustrates the cordless variation of the Ear Gear ITE.

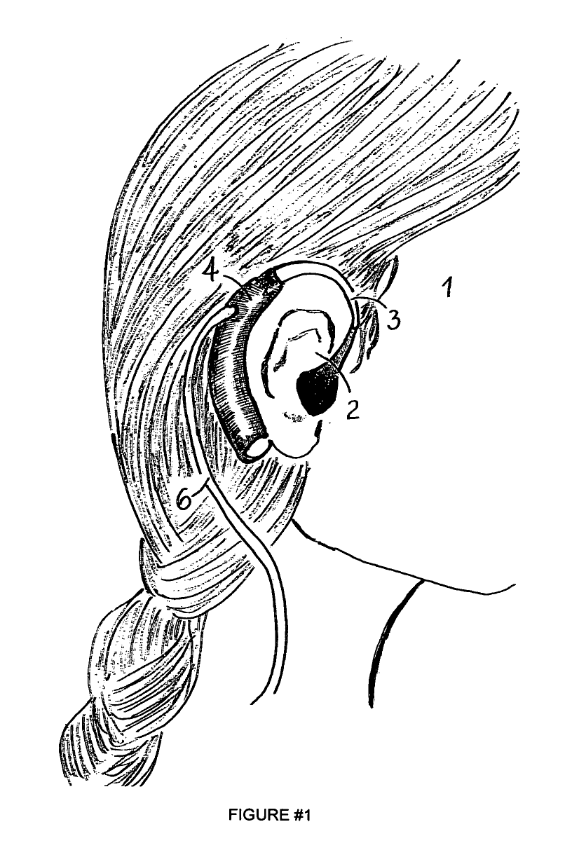

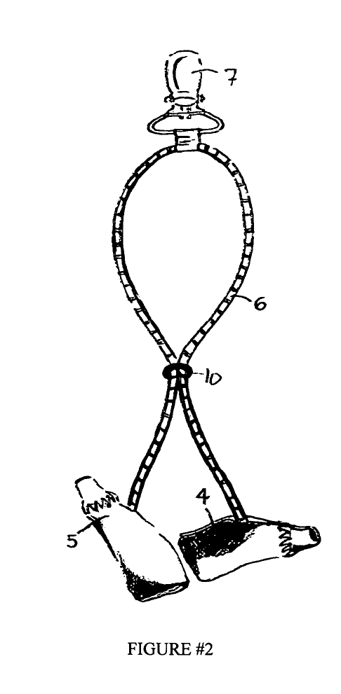

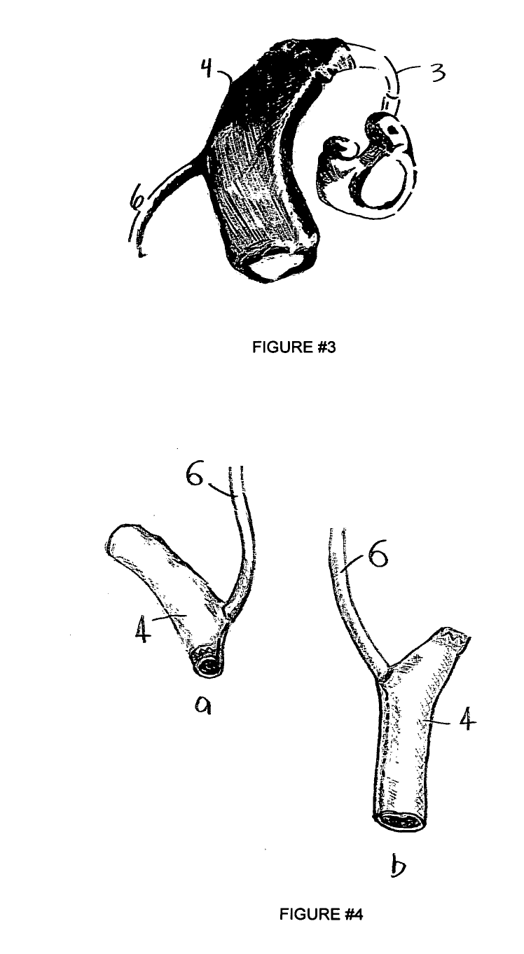

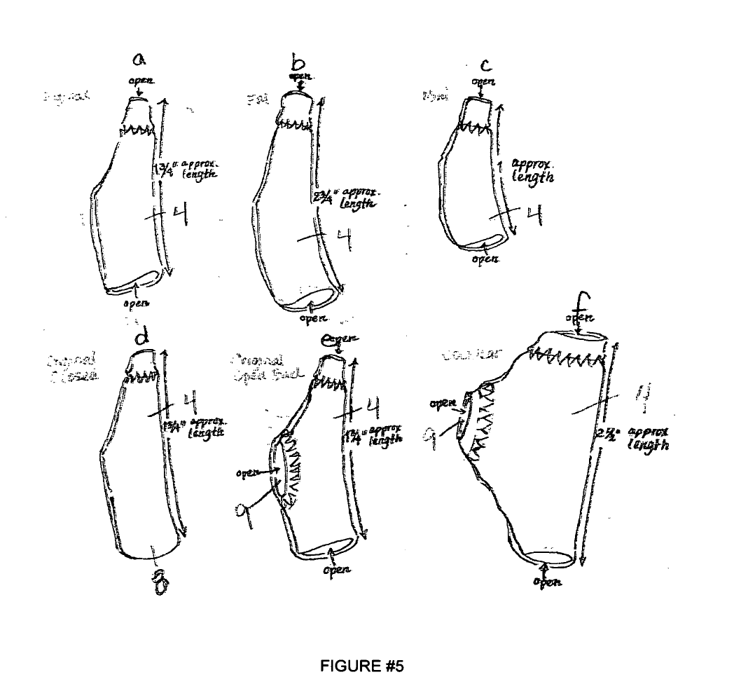

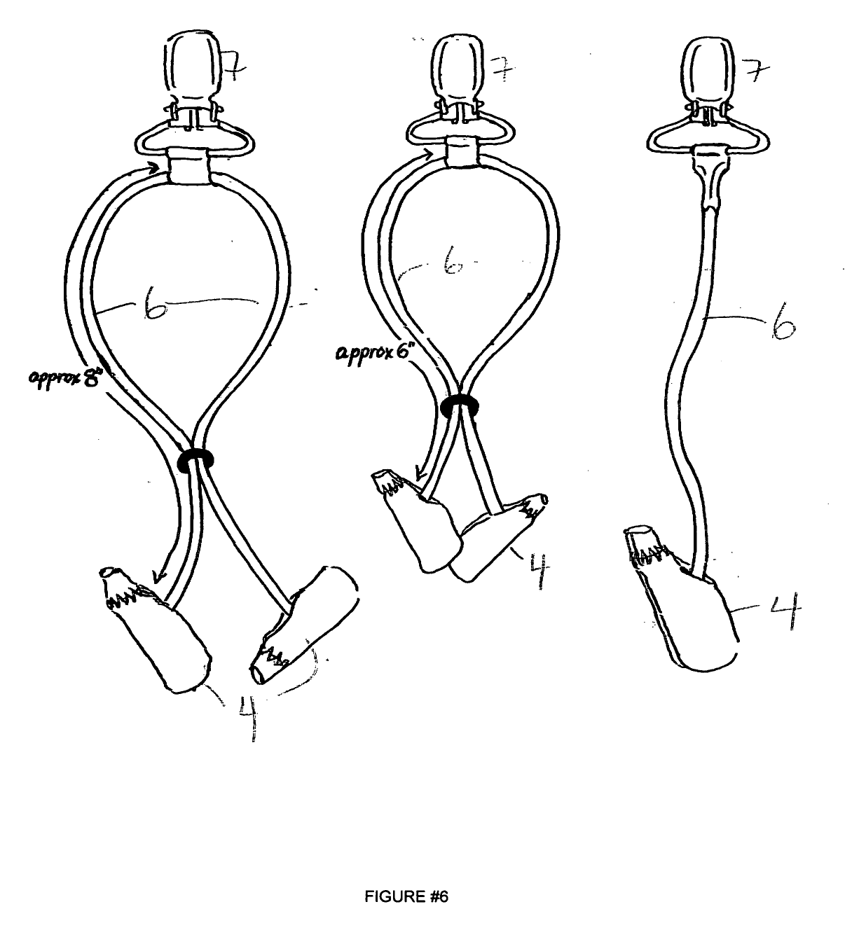

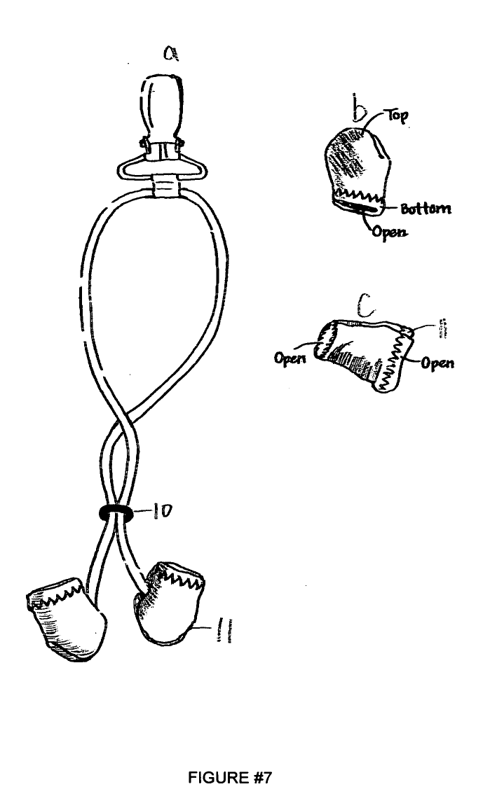

### DETAILED DESCRIPTION OF EMBODIMENT OF THE INVENTION

Referring now in greater detail to FIG. #1 and FIG. #2, in FIG. #1, there is a woman 1 wearing a hearing aid on one side of her ears 2. In the form illustrated, the hearing aid consists of a BTE style aid 3 that is battery operated. The BTE 3 in enclosed inside of a Ear Gear sleeve 4. FIG. #2 illustrates in more detail, an elastic cord 6 has one end attached to the Ear Gear left sleeve 4 and another end attached to the right Ear Gear sleeve 5. At the centre of the cord 6, a clip 7 is attached. FIG. #2 illustrates the plastic cinching ring 10 that reduces lateral movement.

Referring now in greater detail to FIG. #3, FIG. #4a, and FIG. #4b. In FIG. #3 there is in the form illustrated a BTE style aid 3 that is enclosed in a sleeve 4 with the elastic cord 6 leading to the other sleeve 5 (not visible in FIG. #3). Please note that the hook part of the BTE is visible while the body of the BTE is inside the sleeve. FIG. #4a is a sectional illustration of the sleeve 4, showing it from the top and bottom while FIG. #4b is a sectional illustration of the left sleeve 4 from the back of the unit. It shows how the elastic cord 6 is attached. Please note: the smaller opening is ¼″ inch; this is the top of the unit, while the larger opening is ⅝ of an inch , and this is the bottom of the opening.

Referring now in greater detail to FIG. #5. In FIG. #5 there are six forms illustrating the Ear Gear sleeve 4. FIG. #5a illustrates the Original sleeve 4 1¾ inches long. FIG. #5b illustrates the FM sleeve 4 2¾ inches long. FIG. #5c illustrates the Mini sleeve 4 1 inch long. FIG. #5d illustrates the Original sleeve 4 1¾ inches long with a closed bottom. FIG. #5e illustrates the Original sleeve 4 1¾ inches long with an open back to improve access to Volume controls. FIG. #5f illustrates the Cochlear sleeve 4. It is 2½ inches long, it is wider than the original sleeve and has an opening at the back to accommodate the wire cord that connects the Cochlear processor to the Cochlear Hearing aid instrument.

Referring now in greater detail to FIG. #6. In FIG. #6 there are three forms illustrating the Ear Gear cord 6. FIG. #6a illustrates the Original cord 6 approx 8″ long on each side connected to the clip 7. FIG. #6b illustrates the shorter Infant cord 6 approx 6″ long on each side connect to the clip 7. FIG. #6c illustrates mono Ear Gear. The cord is attached to a single sleeve 4 and to the clip 7. In FIG. #6a and #6b the cord is one continuous length that slips through a metal cylinder that is attached to the clip. In FIG. #6c the cord is attached to the clip by crimping a piece of metal to the end of the cord and to the clip.

Referring now in greater detail to FIG. #7. In FIG. #7 there are three forms. FIG. #7a illustrates the IT Ear Gear Unit. It has a plastic cinching ring 10 that reduces lateral movement. It further illustrates the IT sleeve variation. The IT sleeve is smaller to fit IT Hearing Instruments. The cord 6 attaches to the sleeve 11 and clip 7 in the same way as the Ear Gear original. The IT sleeve is the same shape as an IT Hearing aid. The IT hearing aid is a hearing instrument and mold in one piece. The IT sleeve is closed at the top and open on the bottom to accommodate the IT mold. FIG. 7a further illustrates the IT sleeve. FIG. 7b illustrates an IT sleeve variation. The top is open to accommodate smaller IT Hearing Instruments while the bottom continues to remain open to accommodate the IT mold.

The embodiments of the invention in which an exclusive property or privilege is claimed are defined as follows:

1. A Hearing Aid security and protection device encompassing: a sleeve in the same shape as a BTE hearing aid providing security and soft resilient comfort to a wearer. The sleeve has a small opening at the top, approx. ¼ inch long for securely fitting over the hearing aid hook and onto the body of the hearing aid. There is a larger approx. ⅝ inch opening on the bottom that provides access to the battery compartment. The sleeve may range from one inch or less in length (Mini) to long as 2¾ inches (FM) or longer. The Original sleeve is approx. 1¾ inches long.

2. There is a left and right sleeve made of a light woven, breathable fabric. Sleeves can be made from a wide range of fabrics including neoprene, spandex, cotton, and wool. The sleeve may range from one inch or less in length and accommodate an “Open Fit” BTE. It can also range from 2¾ inches long or more and accommodate an FM boot. The Original sleeve is approx. 1¾ inches long.

3. A sleeve in the same shape as an ITE hearing aid providing security and soft resilient comfort to a wearer. The sleeve will either be open at the top or sewn shut. The top of the ITE sleeve is approx. ⅝ inch long and fits securely over the ITE hearing aid. The ITE sleeve covers the outer exposed area of the ITE hearing aid and leaves the ear mold uncovered. The bottom of the ITE sleeve is approx. ¼ inch long and reinforced with stitching. Sleeves can be made from a wide range of fabrics including but not limited to neoprene, spandex or a jersey cotton knit.

4. Attach to the centre back of each sleeve there is piece of stretchy cord that will typically range from approx. 16 to 12 inches in length either sewn to the sleeve or woven from the back in one continuous piece. The left sleeve and right sleeve will both be attached to either end of the cord and at the centre of the cord there will be a clip attached.

5. The cord will be of equal length and attach at the centre to small clip about 2 inches in diameter. It may be one single piece of cord that slides through a cylinder piece of metal attached to the top part of the clip, or the cord maybe attached to the clip in another mode.

6. The clip or fastening device could be plain or could have a range of attractive designs and colors on the surface.

7. There is a cordless variation. The sleeve is used alone.

8. There is a mono variation—the cord length will be approx. half as long as the cord length for the binaural model. There will only be one sleeve attached to the cord and clip.

9. Another variation is an open back sleeve variation. There is an opening that is reinforced with stitching and allows access to controls. This opening may include a flap, fastener such as a Velcro strip or hook and eye.

10. Another variation of the BTE sleeve would include a closed bottom. The bottom may be sewn shut or closed by incorporating a fastener into the design.
